(19) United States
(12) Patent Application Publication
(10) Pub. No.: US 2018/0002142 A1
(43) Pub. Date: Jan. 4, 2018

(54) SIX-PHASE MOTOR FOR ELEVATOR SYSTEM

(71) Applicant: Otis Elevator Company, Farmington, CT (US)

(72) Inventors: Zbigniew Piech, Cheshire, CT (US); Cezary Jedryczka, Lniano (PL); Wojciech Szelag, Poznan (PL)

(21) Appl. No.: 15/540,163

(22) PCT Filed: Dec. 22, 2015
(86) PCT No.: PCT/US2015/067293

§ 371 Date: Jun. 27, 2017

Related U.S. Application Data
(60) Provisional application No. 62/097,681, filed on Dec. 30, 2014.

(51) Int. Cl. B66B 11/04; B66B 9/00; H02K 41/03

(52) U.S. Cl. CPC B66B 11/0407; H02K 41/031; B66B 9/00; B66B 9/003

(57) ABSTRACT

An elevator system includes an elevator car to travel in a hoistway; a linear propulsion system to impart force to the elevator car, the linear propulsion system including: a secondary portion mounted to the elevator car, the secondary portion including a plurality of magnetic poles; and a primary portion mounted in the hoistway, the primary portion including a plurality of coils; and a drive coupled to the primary portion, the drive providing drive signals to at least a section of the primary portion; wherein the drive generates 6 phases of drive signals, each coil associated with one of the 6 phases.

### FIELD OF INVENTION

The subject matter disclosed herein relates generally to the field of elevators, and more particularly to using a six-phase motor to impart force on elevator cars.

### BACKGROUND

Self-propelled elevator systems, also referred to as ropeless elevator systems, are useful in certain applications (e.g., high rise buildings) where the mass of the ropes for a roped system is prohibitive and there is a desire for multiple elevator cars to travel in a single lane. There exist self-propelled elevator systems in which a first lane is designated for upward traveling elevator cars and a second lane is designated for downward traveling elevator cars. A transfer station at each end of the hoistway is used to move cars horizontally between the first lane and second lane.

Existing linear motors that may be employed in an elevator system are three-phase motors. These existing three-phase motors may need to offset or skew drive signals to reduce torque or thrust ripple in the motor. Three-phase motors may also experience high magnitude harmonics in back emf waveforms.

### BRIEF DESCRIPTION OF THE INVENTION

According to one embodiment, an elevator system includes an elevator car to travel in a hoistway; a linear propulsion system to impart force to the elevator car, the linear propulsion system including: a secondary portion mounted to the elevator car, the secondary portion including a plurality of magnetic poles; and a primary portion mounted in the hoistway, the primary portion including a plurality of coils; and a drive coupled to the primary portion, the drive providing drive signals to at least a section of the primary portion; wherein the drive generates 6 phases of drive signals, each coil associated with one of the 6 phases.

In addition to one or more of the features described above or below, or as an alternative, further embodiments could include wherein the primary portion includes 12N coils and the secondary portion includes 22N magnetic poles, where N is a positive integer.

In addition to one or more of the features described above or below, or as an alternative, further embodiments could include wherein a coil pair is associated with each phase of drive signals, wherein current flows in opposite directions in each coil of a respective coil pair.

In addition to one or more of the features described above or below, or as an alternative, further embodiments could include wherein the coils are mounted on a ferromagnetic support.

In addition to one or more of the features described above or below, or as an alternative, further embodiments could include wherein the coils have ferromagnetic cores.

In addition to one or more of the features described above or below, or as an alternative, further embodiments could include wherein the plurality of magnetic poles includes a plurality of permanent magnets.

In addition to one or more of the features described above or below, or as an alternative, further embodiments could include wherein the plurality of permanent magnets are located on one side of the coils.

In addition to one or more of the features described above or below, or as an alternative, further embodiments could include wherein the plurality of permanent magnets are located on both sides of the coils.

In addition to one or more of the features described above or below, or as an alternative, further embodiments could include wherein the plurality of permanent magnets are arranged in a Halbach array.

In addition to one or more of the features described above or below, or as an alternative, further embodiments could include wherein the ratio of a pitch of the magnetic poles to a pitch of the coils is 6/11.

In addition to one or more of the features described above or below, or as an alternative, further embodiments could include wherein the plurality of magnetic poles includes a plurality of excitation coils wound around a plurality of ferromagnetic poles.

According to another embodiment, a linear propulsion includes a primary portion including a plurality of coils; a secondary portion including a plurality of magnetic poles; and a drive coupled to the primary portion, the drive providing drive signals to at least a section of the primary portion; wherein the drive generates 6 phases of drive signals, each coil associated with one of the 6 phases.

In addition to one or more of the features described above or below, or as an alternative, further embodiments could include wherein the primary portion includes 12N coils and the secondary portion includes 22N magnetic poles, where N is a positive integer.

In addition to one or more of the features described above or below, or as an alternative, further embodiments could include wherein a coil pair is associated with each phase of drive signals, wherein current flows in opposite directions in each coil of a respective coil pair.

In addition to one or more of the features described above or below, or as an alternative, further embodiments could include wherein the coils are mounted on a ferromagnetic support.

In addition to one or more of the features described above or below, or as an alternative, further embodiments could include wherein the coils have ferromagnetic cores.

In addition to one or more of the features described above or below, or as an alternative, further embodiments could include wherein plurality of magnetic poles includes a plurality of permanent magnets.

In addition to one or more of the features described above or below, or as an alternative, further embodiments could include wherein the plurality of permanent magnets are located on one side of the coils.

In addition to one or more of the features described above or below, or as an alternative, further embodiments could include wherein the plurality of permanent magnets are located on both sides of the coils.

In addition to one or more of the features described above or below, or as an alternative, further embodiments could include wherein the plurality of permanent magnets are arranged in a Halbach array.

In addition to one or more of the features described above or below, or as an alternative, further embodiments could include wherein the ratio of a pitch of the magnetic poles to a pitch of the coils is 6/11.

In addition to one or more of the features described above or below, or as an alternative, further embodiments could include wherein the plurality of magnetic poles includes a plurality of excitation coils wound around a plurality of ferromagnetic poles.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 depicts an multicar ropeless elevator system in an exemplary embodiment;

FIG. 2 depicts components of a drive system in an exemplary embodiment;

FIG. 3 depicts a drive and a section of the primary portion and the secondary portion of the linear propulsion system in an exemplary embodiment;

FIG. 4 depicts a vector diagram for 6 phase drive signal in an exemplary embodiment;

FIG. 5 depicts a section of the primary portion and the secondary portion of the linear propulsion system in an exemplary embodiment; and

FIG. 6 depicts a secondary portion of the linear propulsion system in an exemplary embodiment.

### DETAILED DESCRIPTION

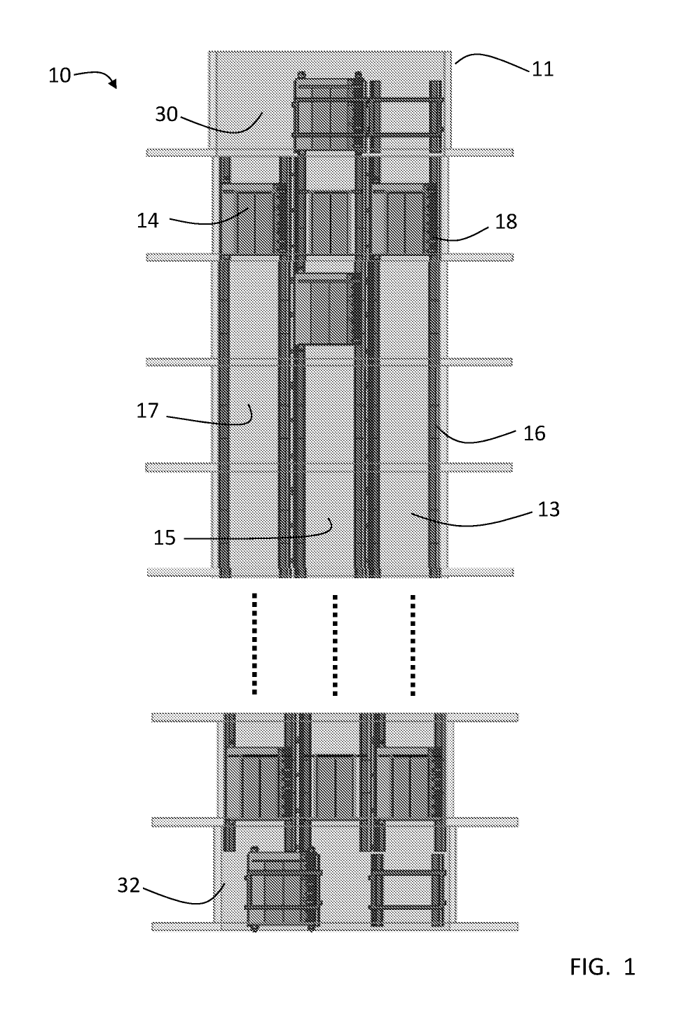

FIG. 1 depicts a multicar, self-propelled elevator system 10 in an exemplary embodiment. Elevator system 10 includes a hoistway 11 having a plurality of lanes 13, 15 and 17. While three lanes are shown in FIG. 1, it is understood that embodiments may be used with multicar, self-propelled elevator systems have any number of lanes. In each lane 13, 15, 17, cars 14 travel in one direction, i.e., up or down. For example, in FIG. 1 cars 14 in lanes 13 and 15 travel up and cars 14 in lane 17 travel down. One or more cars 14 may travel in a single lane 13, 15, and 17. In other embodiments, cars 14 may travel in both directions in a lane.

Above the top floor is an upper transfer station 30 to impart horizontal motion to elevator cars 14 to move elevator cars 14 between lanes 13, 15 and 17. It is understood that upper transfer station 30 may be located at the top floor, rather than above the top floor. Below the first floor is a lower transfer station 32 to impart horizontal motion to elevator cars 14 to move elevator cars 14 between lanes 13, 15 and 17. It is understood that lower transfer station 32 may be located at the first floor, rather than below the first floor. Although not shown in FIG. 1, one or more intermediate transfer stations may be used between the first floor and the top floor. Intermediate transfer stations are similar to the upper transfer station 30 and lower transfer station 32.

Cars 14 are propelled using a linear motor system having a primary, fixed portion 16 and a secondary, moving portion 18. The primary portion 16 includes windings or coils mounted at one or more locations of the lanes 13, 15 and 17. Secondary portion 18 includes magnetic poles (e.g. permanent magnets, electromagnetics) mounted to one or more locations on cars 14. In other embodiments, the secondary portion 18 mounted on car 14 includes coils and the primary portion 16 includes magnetic poles. Primary portion 16 is supplied with drive signals to control movement of cars 14 in their respective lanes.

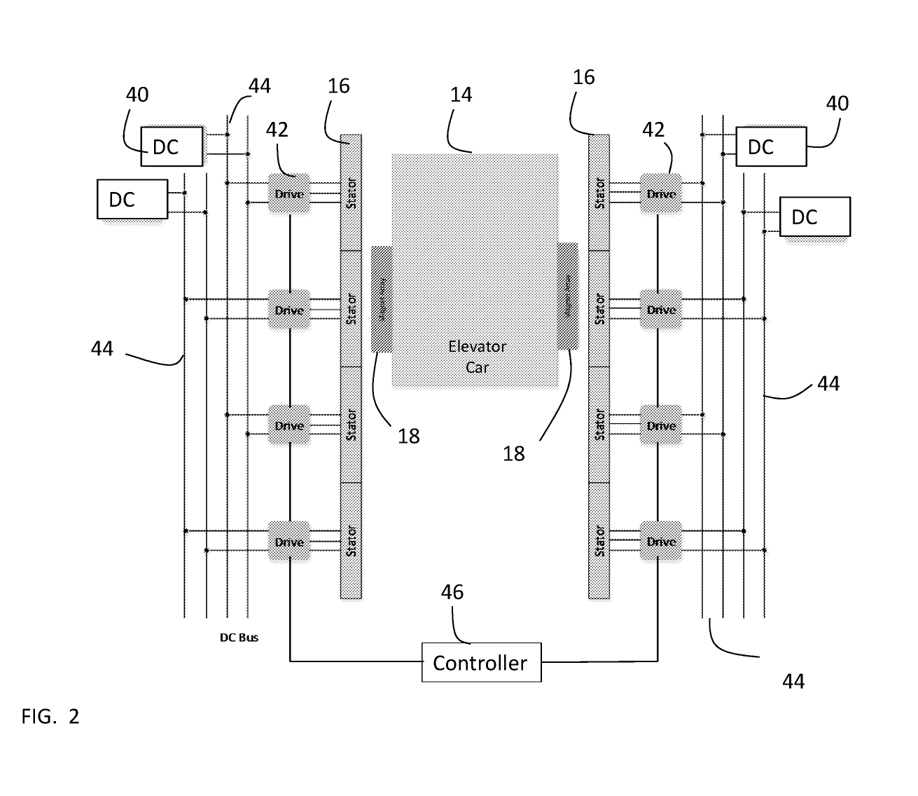

FIG. 2 depicts components of a drive system in an exemplary embodiment. It is understood that other components (e.g., safeties, brakes, etc.) are not shown in FIG. 2 for ease of illustration. As shown in FIG. 2, one or more DC power sources 40 are coupled to one or more drives 42 via one or more DC buses 44. DC power sources 40 may be implemented using storage devices (e.g., batteries, capacitors) or may be active devices that condition power from another source (e.g., rectifiers). Drives 42 receive DC power from the DC buses 44 and provide drive signals to the primary portion 16 of the linear propulsion system. Each drive 42 may be an inverter that conditions DC power from DC bus 44 to a multiphase drive signal provided to a respective section of the primary portions 16. The primary portion 16 is divided into a plurality of motor sections, with each motor section associated with a respective drive 42.

A controller 46 provides control signals to the each of the drives 42 to control generation of the drive signals. Controller 46 may use pulse width modulation (PWM) control signals to control generation of the drive signals by drives 42. Controller may generate dive signals using other techniques, and embodiments are not limited to PWM drive signals. Controller 46 may be implemented using a processor-based device programmed to generate the control signals. Controller 46 may also be part of an elevator control system or elevator management system.

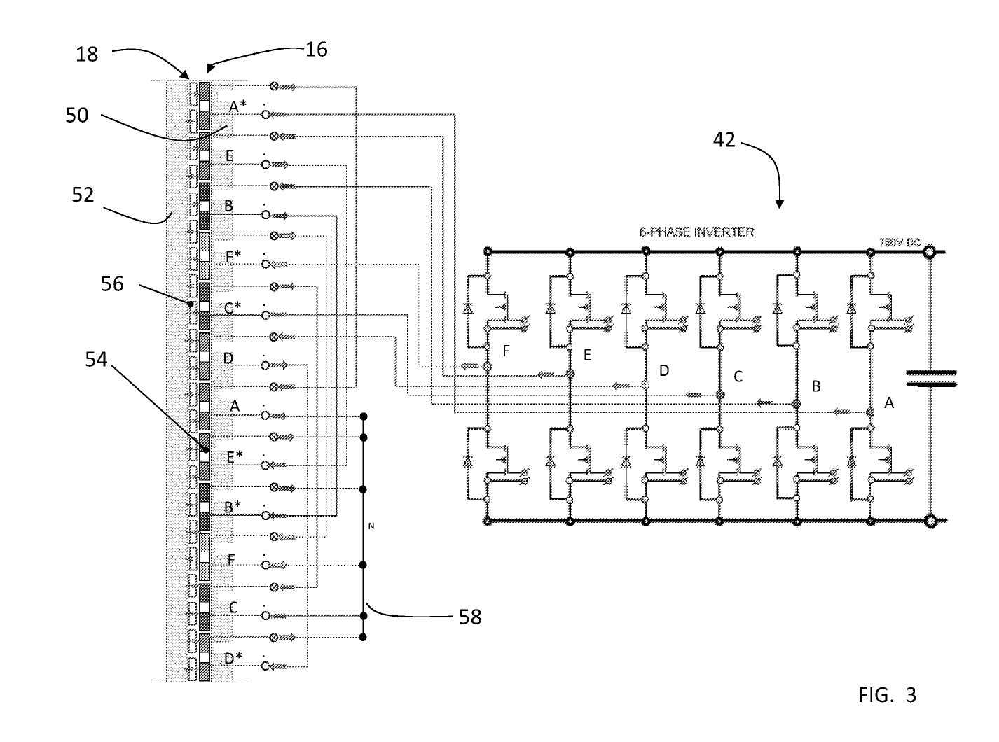

FIG. 3 is schematic diagram of a drive 42 and a section of the primary portion 16 and the secondary portion 18 of the linear propulsion system in an exemplary embodiment. The drive 42 is a two level, six phase drive, have six phase legs labeled A, B, C, D, E, and F. It is understood that the drive 42 may be three level, or N-level, and embodiments are not limited to 2-level drives. In an exemplary embodiment, the primary portion 16 of the linear propulsion system includes 12 coils 54 designated as A*, E, B, F*, C*, D, A, E*, B*, F, C and D*. The letter designates which phase the coil belongs to, and the presence or absence of the * indicates the current direction. A pair of coils 54 is associated with each phase (e.g., A and A*). Current flow in coil A is in the opposite direction as current flow of coil A*. The primary portion 16 of the linear propulsion system can be core-less. Alternatively, coils 54 of the primary portion 16 may be formed about ferromagnetic cores with concentric coils wound around primary teeth. The coils 54 may be also placed on a ferromagnetic flat support 50, forming toothless primary portion 16.

The coils 54 of primary portion 16 are arranged in a star configuration, where coils for each phase (e.g., A and A*) are in electrical series from a respective phase leg of the drive 42 to a neutral point 58. It is understood that other coil configurations may be utilized other than star configuration.

The secondary portion 18 of the linear propulsion system includes 22 magnetic poles 56. The magnetic poles 56 may be arranged as shown in FIG. 3 using 22 permanent magnets, arranged in alternating polarity facing the primary portion 16. In other embodiments, the 22 magnetic poles 56 may be arranged as part of a Halbach array. The spacing of the permanent magnets or poles 56 (e.g., center-to-center) is referred to as the pole pitch. The spacing of the coils 54 (e.g., center-to-center) is referred to as the coil pitch. The ratio of the magnetic pole pitch to the coil pitch equals 6/11. Permanent magnets of secondary portion 18 may be mounted on a ferromagnetic flat support 52. Secondary portion 18 may be positioned on one side of primary portion 16, or on both sides of primary portion 16.

Although FIG. 3 depicts 12 coils and 22 magnetic poles, the linear propulsion system may be generalized as having 12N coils and 22N magnetic poles, where N is a positive integer.

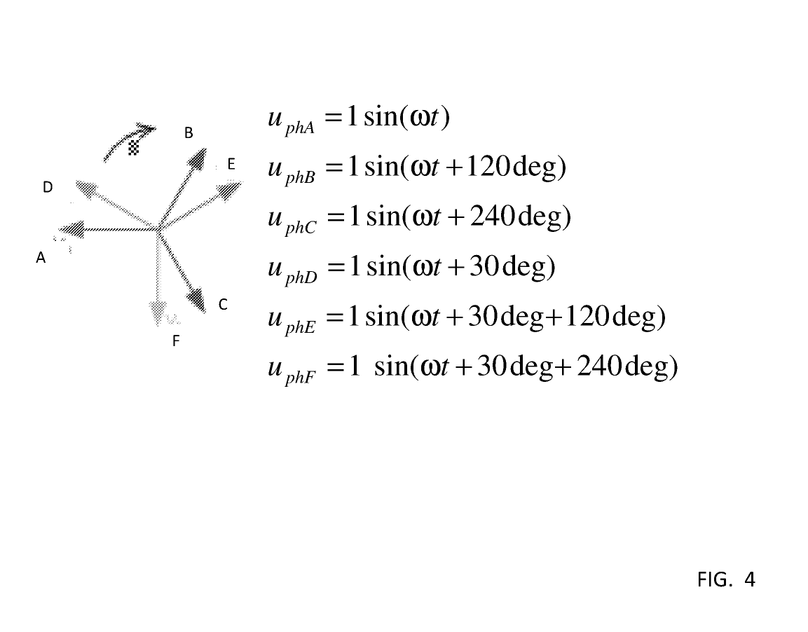

FIG. 4 depicts a vector diagram for 6 phase drive signals, labeled as A, B, C, D, E and F. Phases A, B and C are equally distributed (e.g., 120 degrees electrical apart). Phases D, E and F are also equally distributed (e.g., 120 degrees electrical apart). Phase D is offset from phase A by an offset angle (e.g., 30 degrees electrical), phase E is offset from phase B by an offset angle (e.g., 30 degrees electrical) and phase F is offset from phase C by an offset angle (e.g., 30 degrees electrical). The drive signals in FIG. 4 generate flux in the primary portion 16 which coacts with magnetic poles in the secondary portion 18 to move the car 14 in one direction (e.g. up). To move the car 14 in the opposite direction, the angular offset is reversed with respect to that shown in FIG. 4 (i.e., A=0 deg, B=−120 deg, C=−240 deg, D=−30 deg, E=−30 deg-120 deg, F=−30 deg-240 deg).

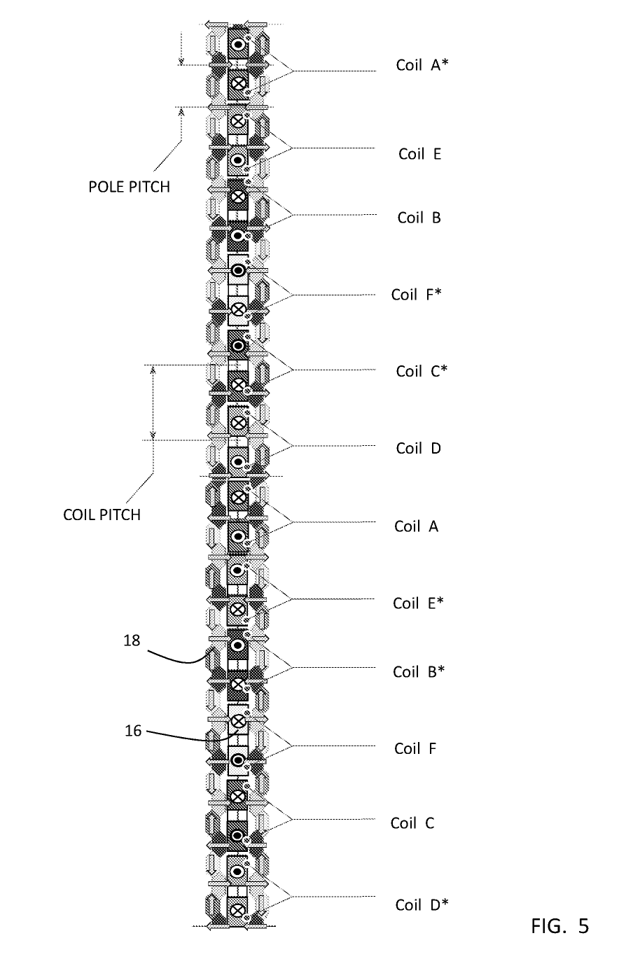

FIG. 5 depicts a section of the linear propulsion system in an exemplary embodiment. FIG. 5 depicts 12 coils of primary portion 16 arranged in the same manner as FIG. 3. FIG. 5 also depicts the permanent magnets for secondary portion 18 arranged in a Halbach array forming the 22 magnetic poles. The coil pitch and pole pitch are also labeled in FIG. 5. Magnetic poles are provided on both sides of the primary portion 16 in FIG. 5.

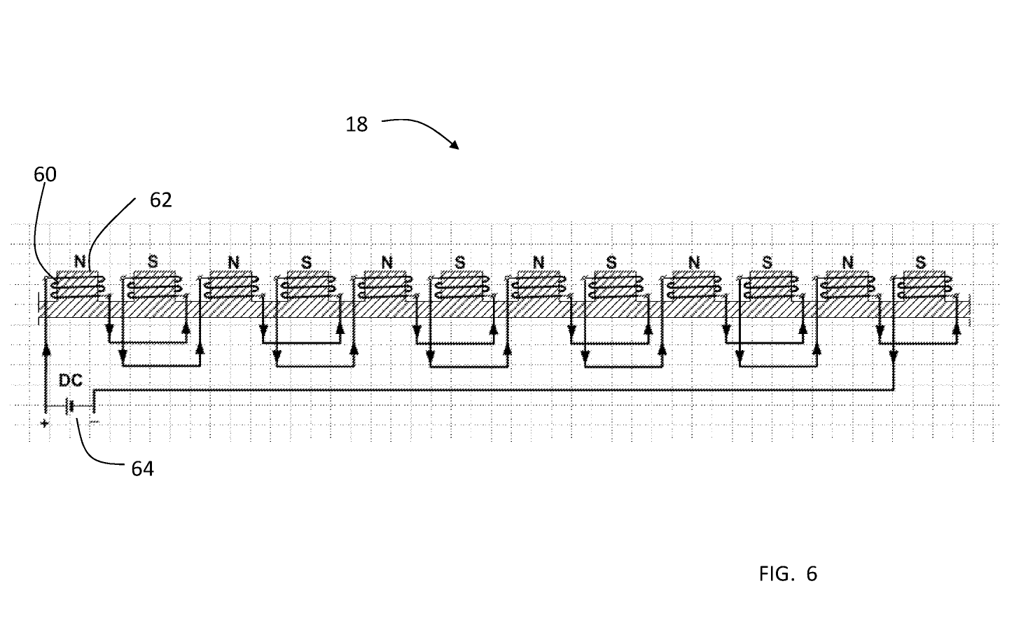

FIG. 6 depicts a secondary portion 18 in another exemplary embodiment. In the embodiment of FIG. 6, the magnetic poles of the secondary portion 18 are implemented using electromagnetics. Each magnetic pole of the secondary portion 18 includes an excitation coil 60 formed around a ferromagnetic pole 62. The excitation coils 60 may be connected in series with a direct current (DC) power source 64. The direction of the winding of excitation coils 60 established the polarity of the magnetic pole facing the primary portion 16, such that the polarity of the magnetic poles alternates along the secondary portion.

Embodiments utilizing a six phase linear propulsion system provide better thermal distribution in the drive compared to existing designs. The six phase linear propulsion system reduces torque and/or thrust ripple, as compared to three phase drives. The six phase linear propulsion system generates lower, high order harmonics. Also, using six phases allows the drive 42 to use lower power rated transistors (e.g., IGBTs) in higher volume, which reduces cost.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An elevator system comprising:
an elevator car to travel in a hoistway;
a linear propulsion system to impart force to the elevator car, the linear propulsion system comprising:
a secondary portion mounted to the elevator car, the secondary portion including a plurality of magnetic poles; and
a primary portion mounted in the hoistway, the primary portion including a plurality of coils; and
a drive coupled to the primary portion, the drive providing drive signals to at least a section of the primary portion;
wherein the drive generates 6 phases of drive signals, each coil associated with one of the 6 phases.

2. The elevator system of claim 1, wherein the primary portion includes 12N coils and the secondary portion includes 22N magnetic poles, where N is a positive integer.

3. The elevator system of claim 1, wherein a coil pair is associated with each phase of drive signals, wherein current flows in opposite directions in each coil of a respective coil pair.

4. The elevator system of claim 1, wherein the coils are mounted on a ferromagnetic support.

5. The elevator system of claim 1, wherein the coils have ferromagnetic cores.

6. The elevator system of claim 1, wherein the plurality of magnetic poles includes a plurality of permanent magnets.

7. The elevator system of claim 6, wherein the plurality of permanent magnets are located on one side of the coils.

8. The elevator system of claim 6, wherein the plurality of permanent magnets are located on both sides of the coils.

9. The elevator system of claim 6, wherein the plurality of permanent magnets are arranged in a Halbach array.

10. The elevator system of claim 1, wherein the ratio of a pitch of the magnetic poles to a pitch of the coils is 6/11.

11. The elevator system of claim 1, wherein the plurality of magnetic poles includes a plurality of excitation coils wound around a plurality of ferromagnetic poles and a power source coupled to the excitation coils.

12. A propulsion system comprising:
a primary portion including a plurality of coils;
a secondary portion including a plurality of magnetic poles; and
a drive coupled to the primary portion, the drive providing drive signals to at least a section of the primary portion;
wherein the drive generates 6 phases of drive signals, each coil associated with one of the 6 phases.

13. The propulsion system of claim 12, wherein the primary portion includes 12N coils and the secondary portion includes 22N magnetic poles, where N is a positive integer.

14. The propulsion system of claim 12, wherein a coil pair is associated with each phase of drive signals, wherein current flows in opposite directions in each coil of a respective coil pair.

15. The propulsion system of claim 12, wherein the coils are mounted on a ferromagnetic support.

16. The propulsion system of claim 12, wherein the coils have ferromagnetic cores.

17. The propulsion system of claim 12, wherein plurality of magnetic poles includes a plurality of permanent magnets.

18. The propulsion system of claim 17, wherein the plurality of permanent magnets are located on one side of the coils.

19. The propulsion system of claim 17, wherein the plurality of permanent magnets are located on both sides of the coils.

20. The propulsion system of claim 17, wherein the plurality of permanent magnets are arranged in a Halbach array.

21. The propulsion system of claim 12, wherein the ratio of a pitch of the magnetic poles to a pitch of the coils is 6/11.

22. The propulsion system of claim 12, wherein the plurality of magnetic poles includes a plurality of excitation coils wound around a plurality of ferromagnetic poles and a power source coupled to the excitation coils.
